(19) United States
(12) Patent Application Publication
(10) Pub. No.: US 2013/0005042 A1
(43) Pub. Date: Jan. 3, 2013

(54) HYBRID SINGLE MOLECULE IMAGING SORTER

(75) Inventor: Xin Heng, Hercules, CA (US)

(73) Assignee: Bio-Rad Laboratories, Inc., Hercules, CA (US)

(21) Appl. No.: 13/340,504

(22) Filed: Dec. 29, 2011

Related U.S. Application Data
(60) Provisional application No. 61/428,535, filed on Dec. 30, 2010.

(51) Int. Cl. G01N 21/64

(52) U.S. Cl. 436/94; 422/82.08

(57) ABSTRACT

A system for characterizing and sorting individual molecules, for example chromatin or DNA molecules. In some configurations, the system can immobilize molecules of interest suspended in fluid in a sample stage for characterization, and selectively release the immobilized molecules to different output reservoirs, depending on the characterization result. For example, fluorescent markers may be hybridized onto molecules, which may then be attached to dielectric beads and immobilized using holographic optical tweezers or other means. The system may provide elongational flow to elongate molecules, and may detect the presence and spacing of multiple fluorescent markers hybridized to the molecules. Using advanced techniques, the system may be able to characterize features with a resolution better than the theoretical resolution of the system optics. The system may utilize a microfluidic cartridge.

This application claims the benefit of U.S. Provisional Patent Application No. 61/428,535 filed Dec. 30, 2010 and titled “Hybrid Single Molecule Imaging Sorter”, the entire disclosure of which is hereby incorporated by reference herein.

### BACKGROUND OF THE INVENTION

In research and diagnostic applications, it is often desirable to collect small units of biological material having common characteristics. For example, cells exhibiting particular characteristics may be identified from a larger population of cells and collected for further analysis or experimentation.

In genetic research or other fields, it may be desirable to identify and isolate structures as small as a single molecule, based on features smaller than a single molecule. Conventional optical systems cannot resolve the level of detail needed to identify certain submolecular features of interest. For example, a conventional optical microscope typically cannot resolve features smaller than about 200 nanometers. Other kinds of imaging devices, for example the scanning electron microscope, can achieve higher resolution than optical microscopes, but are not suitable for many biological applications.

### BRIEF SUMMARY OF THE INVENTION

According to one aspect, a system for sorting molecules includes a light source that illuminates an imaging region of a sample stage containing a molecule of interest, an electronic image sensor, an optical system that projects an image of the imaging region onto the electronic image sensor, at least one fluid input channel that admits fluid into the sample stage, at least one fluid output channel through which fluid can leave the sample stage, and a system for immobilizing molecules of interest suspended in fluid in the sample stage and selectively releasing the immobilized molecules. In some embodiments, the system for immobilizing molecules of interest includes a trapping laser and a light modulating device that modulates light from the trapping laser into a plurality of focused beams that act as optical tweezers. In some embodiments, the system further includes a computerized processing unit that receives signals from the electronic image sensor and constructs a digital image of the imaging region of the sample stage, identifies the locations of particular molecules of interest, and programs the light modulating device to generate the plurality of focused beams that immobilize the particular molecules of interest using optical tweezers. The computerized processing unit may further program the light modulating device to selectively shut off one of the converging beams to release a corresponding molecule. The light modulating device may be a spatial light modulator. The system for immobilizing molecules of interest may include a chemical bond between a molecule of interest and a portion of the sample stage. In some embodiments, the system includes at least two fluid output channels through which fluid can leave the sample stage, and further includes a switching device that selectively directs fluid flow to one of the fluid output channels. In some embodiments, the system includes a computerized processing unit that receives signals from the electronic image sensor and constructs a digital image of the imaging region of the sample stage, identifies the locations of molecules of interest, and causes at least one molecule to be selectively released. In some embodiments, the computerized processing unit further controls the flow of fluid into and out of the sample stage, and switches on and off the light source. In some embodiments, the system includes a computerized processing unit that receives signals from the electronic image sensor and constructs a digital image of the imaging region of the sample stage, and identifies the locations of molecules of interest based on the presence of a particular fluorophore tagged to at least some of the molecules. In some embodiments, the system includes a computerized processing unit that receives signals from the electronic image sensor and constructs a digital image of the imaging region of the sample stage, and identifies the locations of molecules of interest based on the presence of two fluorophores tagged to at least some of the molecules. The computerized processing unit may measure the distance between two fluorophore tags on a single molecule to a resolution that is smaller than the resolution of the optical system.

According to another aspect, a method of sorting molecules includes admitting fluid into a sample stage, the fluid carrying a set of molecules, at least some of which are tagged with fluorophores, and identifying a subset of the molecules based on the locations of the fluorophore tags. The method further includes immobilizing at least some of the molecules in the subset, and washing from the sample stage molecules that are not immobilized. In some embodiments, immobilizing at least some of the molecules includes providing a plurality of focused beams that immobilize at least some of the molecules using optical tweezers. Immobilizing at least some of the molecules may include bonding a dielectric object to at least one molecule, and immobilizing the dielectric object using the optical tweezer. Identifying the subset of the molecules may include detecting that certain molecules are tagged with a particular fluorophore tag. Identifying the subset of the molecules may include detecting that certain molecules are tagged with two fluorophore tags. Indentifying the subset of the molecules may include measuring the spatial separation of the two fluorophore tags on a particular molecule. In some embodiments, measuring the spatial separation of the two fluorophore tags on a particular molecule includes measuring the separation using statistical techniques to measure a separation that is smaller than a resolution limit of an imaging system used to detect the fluorophore tags. The two fluorophore tags emit light having different wavelength characteristics.

According to another aspect, a microfluidic cartridge includes a molecule fluid input reservoir, a washing fluid input reservoir, at least two output reservoirs, a sample area comprising a transparent portion enabling immobilization of molecules in the sample area using optical tweezers, and a system of channels connecting the reservoirs with the sample area. The microfluidic cartridge further includes a pump for delivering fluid from the molecule fluid input reservoir to the sample area, a pump for delivering fluid from the washing fluid input reservoir to the sample area, a set of valves for selectively directing fluid flowing from the sample area to the at least two output reservoirs, and a set of control lines to actuate the pumps and valves.

### BRIEF DESCRIPTION OF THE DRAWINGS

FIG. 1 illustrates a simplified diagram of a system in accordance with embodiments of the invention.

FIG. 2A illustrates a view of a sample stage into which molecules have been introduced.

FIG. 2B illustrates a view of the sample stage of FIG. 2A in a later portion of a sorting process.

FIG. 2C illustrates a view of the sample stage of FIG. 2A in a later portion of a sorting process.

FIG. 3 illustrates a view of the sample stage of FIG. 2A, undergoing elongational flow.

FIG. 4 illustrates a simplified view of a microfluidic cartridge, in accordance with embodiments of the invention.

### DETAILED DESCRIPTION OF THE INVENTION

According to embodiments of the invention, advanced optical and sample manipulation techniques are used to sort single molecules based on sensing or measurement of submolecular features.

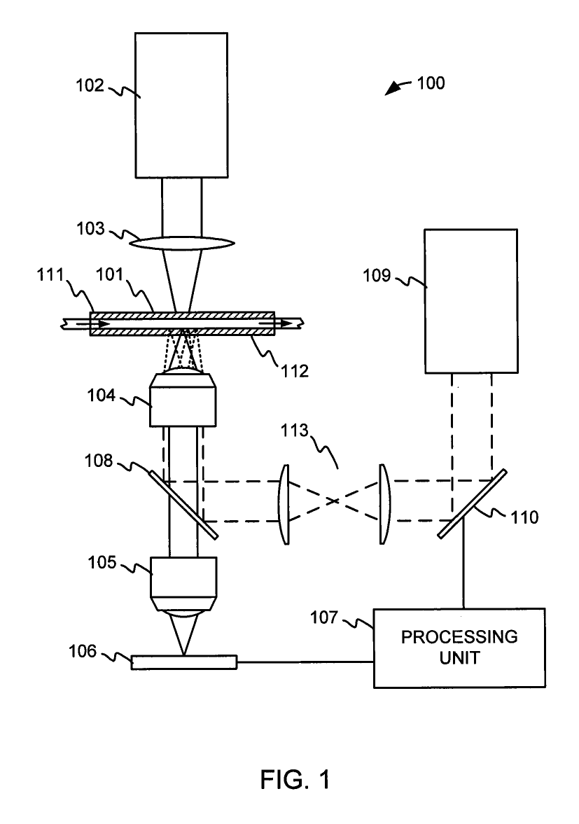

FIG. 1 illustrates a simplified diagram of a system 100 in accordance with embodiments of the invention. Example system 100 includes a sample stage 101, where material of interest is placed for imaging and processing. Sample stage 101 may be, for example, a portion of a microfluidic cartridge, or may be a more conventional arrangement including or similar to a glass slide. The molecules of interest may be suspended in a fluid-filled layer or chamber.

An area of sample stage 101 to be imaged is illuminated by excitation laser 102. Excitation laser 102 may be of any suitable type and may produce a beam of any suitable power and wavelength. In one embodiment, excitation laser 102 produces light having a wavelength of 532 nm, at a power of between about 100 mW and about 1000 mW. The beam from excitation laser 102 may be weakly converged by a condenser lens 103, so that sufficient illumination reaches sample stage 101. For example, the area of sample stage 101 to be imaged may be illuminated with an intensity of between about 1 kW/cm² and about 10 kW/cm². In some embodiments, the imaged area of sample stage 101 may be about 20-100 microns across, for example about 50 microns across.

An objective lens 104 cooperates with a tube lens 105 to form an image on sensor 106. Objective lens 104 may be, for example a 60× objective with a numerical aperture (NA) of 1.3, although lenses having other parameters may be used. Sensor 106 may be, for example, an electronic sensor comprising an array of photosensitive sites, and may utilize charge coupled devices (CCD) or complementary metal oxide semiconductor (CMOS) technology. Other kinds of sensors may be used. Sensor 106 may be a component of a camera, but no additional camera structure is shown in FIG. 1 so as not to obscure the operation of the system in unnecessary detail. Signals from sensor 106 are passed to a processing unit 107, which may be a desktop computer or other processing device. Processing unit 107 can construct a digital image of the imaged area of sample stage 101, may control the operation of sensor 106, and may also control the operation of other parts of the system as described in more detail below.

The components of system 100 described so far are parts of a high resolution optical microscope, for example a total internal reflection fluorescence (TIRF) microscope. In one example mode of operation, light from excitation laser 102 excites fluorescence of tagging structures within the imaged area of sample stage 101, and sensor 106 detects light emitted from the structures as a result of the fluorescence.

Objective lens 104 and tube lens 105 may form an “infinity space” between them, enabling the insertion of filter 108 or other components. Filter 108 may be, for example, a dichroic filter that substantially transmits light of wavelengths near the emission peak of any fluorescent tags in the imaging area, but substantially reflects light of the wavelength emitted by excitation laser 102.

Exemplary system 100 also includes a trapping laser 109. Trapping laser 109 may, for example, produce light in infrared wavelengths at a power of between 50 mW and 200 mW. Trapping laser 109 may be used for manipulation of molecules at sample stage 101 using the technique known as optical tweezers. The optical tweezer technique can hold or “trap” small dielectric objects in three dimensions near the beam waist of a highly focused laser beam. In system 100, the beam of trapping laser 109 is altered by a modulation device 110. Modulation device 110 may be, for example, a spatial light modulator, an array of micro electromechanical system (MEMS) mirrors, or another device that is programmable to produce an output beam having arbitrary characteristics given a known input beam. Modulation device 110 may also be controlled by processing unit 107. For example, processing unit 107 may cause a number of beams to converge (via objective lens 104) at specific locations within the area being imaged at sample stage 101, to trap a number of particles as described in more detail below.

System 100 may also include a one or more fluid input channels 111, and one or more fluid output channels 112, for introducing molecules to and delivering molecules from sample stage 101. Optional relay optics 113 may provide flexibility in the positioning of components of system 100.

The arrangement of system 100 is exemplary, and not limiting, and other arrangements may be used. For example, in system 100, sensor 106 receives an image by transmission through filter 108, and light from trapping laser 109 reaches sample stage by reflection from filter 108. The positions of sensor 106 and trapping laser 109 could be reversed, such that light from trapping laser 109 reaches sample stage 101 by transmission, and sensor 106 receives light by reflection. Other modifications are also possible.

System 100 may be used for cell sorting in at least two modes.

In a first mode, a set of molecules or other structures to be sorted is introduced into sample stage 101, for example by being carried into sample stage 101 by a fluid through fluid input channel 111. The molecules may have previously been subjected to a tagging process, so that molecules exhibiting a particular characteristic include a fluorescent tag, while molecules lacking that characteristic are not tagged. For example, the molecules may be DNA molecules that have previously been exposed to a nicking endonuclease that recognizes a specific sequence motif. Each molecule may also be affixed, using known methods, to a dielectric object, such as a polystyrene bead.

Once the set of molecules is in the imaging area of sample stage 101, the imaging area is illuminated by excitation laser 102 and the locations of the fluorescent tags are detected using the microscope portion of system 100. For each of the molecules of interest showing the presence of the fluorescent tags, modulation device 110 is programmed to produce an optical tweezer that constrains the corresponding polystyrene bead. This array of optical tweezers may be called a “holographic optical tweezer”.

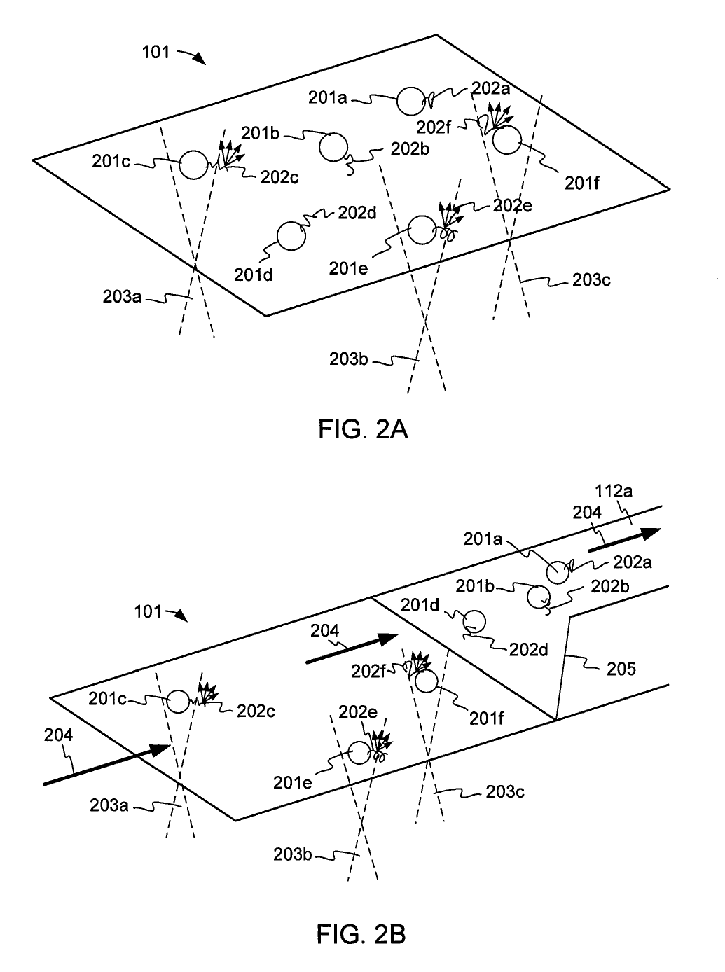

FIG. 2A illustrates a view of sample stage 101 once the molecules have been introduced. In this example, each of beads 201a-201f has affixed to it a respective molecule 202a-202f. The molecules may be coiled such that they are not separately resolvable by the microscope. However, light emanating from the fluorescent tags may be detected by the microscope, without resolving the actual molecules. In the example of FIG. 2, molecules 202c, 202e, and 202f are shown as emitting light by fluorescence, and are thus identified as being tagged. It is therefore possible to identify the locations of several molecules that are tagged (202c, 202e, 202f). Modulation device 110 is then programmed, using processing unit 107, to provide an array of optical tweezer beams 203a-203c directed at the beads corresponding to the tagged molecules. This holographic optical tweezer immobilizes the tagged molecules. The untagged molecules (not immobilized by the holographic optical tweezer) may then be washed from sample stage 101 by fluid flow 204, as illustrated in FIG. 2B. The untagged molecules may be collected for further analysis or experimentation, if desired. A switching device 205 may direct the untagged molecules to a particular fluid output channel 112a. Switching device 205 is preferably under the control of processing unit 107, and may be, for example, an optical, optomechanical, fluidic, or electromechanical device.

The immobilized group of molecules may then later be released by shutting off trapping laser 109, and that group of molecules washed from sample stage 101 as illustrated in FIG. 2C. Switching device 205 may be adjusted so that the tagged molecules are directed by fluid flow 204 to fluid output channel 112b. The tagged molecules may be collected downstream for further analysis or experimentation, if desired. Selected molecules may be released by reprogramming modulation device 110 to shut off selected optical tweezer beams.

Another set of molecules and associated beads may then be introduced to sample stage and the separation process repeated. It will be recognized that carriers other than dielectric beads may be used, including oil droplets, water droplets, or other kinds of carriers.

In this way, molecules can be separated or sorted, even though the molecules themselves may not be resolvable by system 100. While the above example is presented as sorting DNA molecules, system 100 may also be used to sort other structures, such as other nucleic acids or chromatin.

Other methods could also be used for immobilizing and selectively releasing particular groups of molecules. For example, the set of molecules including both the tagged and untagged groups could be bonded to a surface of sample stage 101 by any appropriate chemical attachment such as biotin-avidin chemistry or another kind of bonding. The locations of molecules in the tagged and untagged groups would be identified optically in a manner similar to that described above, and then the bonds of the molecules in one of the groups would be broken, for example photochemically. The molecules in the first group freed would be washed from sample stage 101 and collected if desired. Subsequently, the bonds of the molecules in the other group would be broken, and the molecules in the second group washed from sample stage 101 and collected if desired.

In a second mode of operation, the DNA molecules or other structures are stretched to nearly full extension in an elongational flow environment. That is, once the structures are immobilized within sample stage 101, the fluid in which the molecules are suspended is caused to flow through sample stage 101. As a result, the molecules may unfurl to an elongated state, allowing detection of additional features.

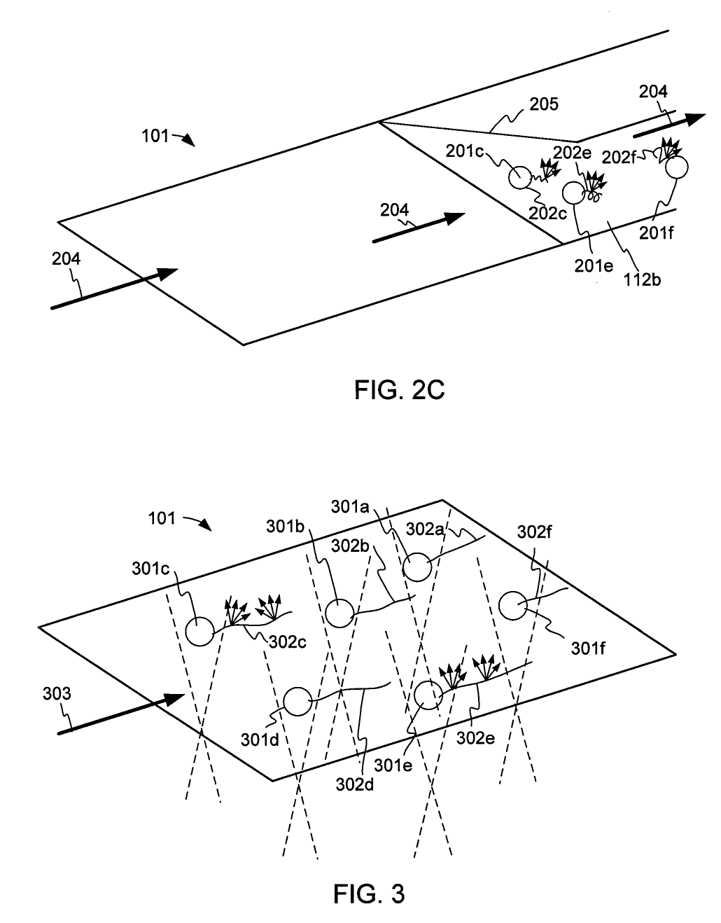

For example, multiple fluorescent tags may be hybridized onto chromatin strands, and the separation distance between the tags may be of interest. FIG. 3 illustrates a view of sample stage 101 undergoing elongational flow. In this example, chromatin strands 302a-302f are bonded to dielectric beads 301a-301f. Fluid flow 303 is sufficient to extend the molecules. At least some of the chromatin strands exhibit two fluorescing tags. Because the strands are elongated, the physical separation distance between the two tags is a good indication of how far the two tags are separated along the chromatin strand, as measured in base pairs. In some embodiments, the two tags on each tagged strand comprise different fluorophores, so that the two tags can be detected separately. For example, the sample may be illuminated only with laser light of a first wavelength to which a first of the fluorophores is most sensitive, and the locations determined of the tags including the first fluorophore. The sample may then be illuminated only with laser light of a second wavelength to which a second of the fluorophores is most sensitive, and the locations determined of the tags including the second fluorophore. Conveniently, excitation laser 102 may be capable of emitting beams of different wavelengths at different times. Such a laser is available from Vortran Laser Technology, Inc., of Sacramento, Calif., USA. Alternatively, separate lasers may be used. In another technique, the two fluorophores to be detected may be responsive to the same excitation wavelength, and the detection of the different emission spectra of the two fluorophores may be accomplished with the aid of filters.

Even though the tags themselves may not be resolvable, their locations may be determined with great accuracy using advanced image processing techniques. For example, the centroid of an optical spot may be determined for each of the fluorophores with much greater accuracy than the Rayleigh limit of the optics, and the separation of the centroids computed. The accuracy with which the centroid spacing can be determined is on the order of λ/2\sqrt{N}, where λ is the wavelength of the emitted light and N is the number of photons collected. It may be possible to measure separation distances as small as 10-20 nm, or less than about 100 DNA base pairs. Even tags having the same fluorophore may be utilized and their separation difference measured with good accuracy using temporal differences in photobleaching of the fluorophore at the two tag sites. Techniques for characterizing the locations tag centroids are described in Matthew P. Gordon et al., “Single-molecule high-resolution imaging with photobleaching”, Proceedings of the National Academy of Sciences, vol. 101 no. 17, pp. 6462-6465, Apr. 27, 2004, the entire disclosure of which is hereby incorporated by reference herein.

Once the characteristics of the molecules of interest are measured, individual molecules or sets of molecules may be selectively released and separately collected as previously described.

In some embodiments, many of the sample manipulation and sorting functions of system 100 may be accomplished using a microfluidic cartridge. A microfluidic cartridge, also called a chip, is a device that may be fabricated at least in part using techniques similar to those used in integrated circuit manufacturing, for example lithography. A microfluidic cartridge may include a set of reservoirs in which input reagents are deposited, and a set of very small channels that enable reagents from the input reservoirs to be moved and directed to other features on the cartridge, for example reaction chambers or output reservoirs. Pumps, valves, and other features may be formed in relatively soft material of the cartridge, and actuated by external application of pressurized fluid or gas under computer control.

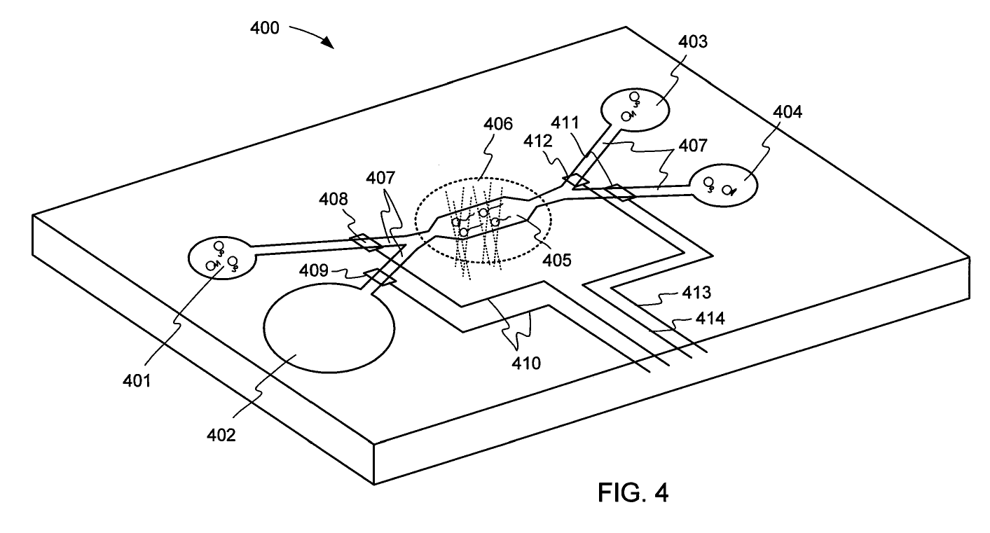

FIG. 4 illustrates a simplified view of a microfluidic cartridge 400, in accordance with embodiments of the invention. Microfluidic cartridge 400 may be of a size and shape compatible with the well-known SBS format for microfluidic cartridges, or may be of another size and shape.

Microfluidic cartridge 400 may comprise a set of input reservoirs including a molecule fluid input reservoir 401 and a washing fluid input reservoir 402, and may comprise a set of output reservoirs, including reservoirs 403 and 404 for receiving sorted molecules. A sample area 405 is provided, and at least a portion of microfluidic cartridge 400, such as for example portion 406, may be transparent so that sample area 405 can be illuminated and imaged, for example in a system such as system 100. A set of channels 407 may connect reservoirs 401-404 and sample area 405. Pumps 408 and 409 are controllable using control lines 410 to selectively transport fluid from molecule fluid input reservoir 401 and washing fluid input reservoir 402 to sample area 405. (Control lines 410 are simplified in FIG. 4. For example, pumps 408 and 409 may be peristaltic pumps requiring sequential activation of three or more valves for each pump.)

Valves 411 and 412 are controlled by control lines 413 and 414 respectively, to selectively enable or block flow from sample area 405 to output reservoirs 403 and 404. Fluid flowing from sample area 405 may thus be directed to one or more particular output reservoirs by opening the valve or valves corresponding to those reservoirs, and flow of fluid to other output reservoirs may be blocked by closing the corresponding valves.

In operation, at least part of microfluidic cartridge 400 may serve as sample stage 101 of system 100. Processing unit 107 may actuate (possibly through the use of intermediate components not shown) control lines 410, 413, and 414 to operate pumps 408 and 409 and valves 411 and 412.

In one example operation sequence, a solution including molecules to be sorted may be placed in molecule fluid input reservoir 401, and a washing fluid placed in washing fluid input reservoir 402. Microfluidic cartridge 400 may then be placed in system 100. Under control of processing unit 107, a quantity of the molecule-containing solution may be moved into sample area 405, where molecules having a property of interest are identified. Some of the molecules may be immobilized (either the molecules having the property of interest, or those not having the property of interest). Valves 411 and 412 are configured, under control of processing unit 107, to direct any fluid exiting sample area 405 to a particular one of the output reservoirs, for example output reservoir 403. A quantity of washing fluid may then be introduced from washing fluid input reservoir 402 to sample area 405, carrying any non-immobilized molecules out of sample area 405 and to output reservoir 403.

Once the non-immobilized molecules have been cleared from sample area 405, valves 411 and 412 may be configured to direct fluid flowing out of sample area 405 to a different output reservoir, for example output reservoir 404. The previously immobilized molecules are then released, and washing fluid is again introduced to sample area 405, carrying the released molecules to output reservoir 404. In this way, the molecules are sorted such that molecules having the property of interest are directed to one of the output reservoirs, and molecules lacking the property of interest are directed to a different one of the output reservoirs. The process may be repeated if additional molecule-containing fluid is present in molecule fluid input reservoir 401.

It will be recognized that a microfluidic cartridge such as cartridge 400 may be used in either molecule sorting mode described above.

In the claims appended hereto, the term “a” or “an” is intended to mean “one or more.” The term “comprise” and variations thereof such as “comprises” and “ comprising,” when preceding the recitation of a step or an element, are intended to mean that the addition of further steps or elements is optional and not excluded. The invention has now been described in detail for the purposes of clarity and understanding. However, those skilled in the art will appreciate that certain changes and modifications may be practiced within the scope of the appended claims.

What is claimed is:

1. A system for sorting molecules, the system comprising:
a light source that illuminates an imaging region of a sample stage containing a molecule of interest;
an electronic image sensor;
an optical system that projects an image of the imaging region onto the electronic image sensor;
at least one fluid input channel that admits fluid into the sample stage;
at least one fluid output channel through which fluid can leave the sample stage; and
a system for immobilizing molecules of interest suspended in fluid in the sample stage and selectively releasing the immobilized molecules.

2. The system of claim 1, wherein the system for immobilizing molecules of interest comprises:
a trapping laser; and
a light modulating device that modulates light from the trapping laser into a plurality of focused beams that act as optical tweezers.

3. The system of claim 2, further comprising a computerized processing unit that:
receives signals from the electronic image sensor and constructs a digital image of the imaging region of the sample stage;
identifies the locations of particular molecules of interest; and
programs the light modulating device to generate the plurality of focused beams that immobilize the particular molecules of interest using optical tweezers.

4. The system of claim 3, wherein the computerized processing unit further programs the light modulating device to selectively shut off one of the converging beams to release a corresponding molecule.

5. The system of claim 2, wherein the light modulating device is a spatial light modulator.

6. The system of claim 1, wherein the system for immobilizing molecules of interest comprises:
a chemical bond between a molecule of interest and a portion of the sample stage.

7. The system of claim 1, wherein the system comprises at least two fluid output channels through which fluid can leave the sample stage, and wherein the system further comprises a switching device that selectively directs fluid flow to one of the fluid output channels.

8. The system of claim 1, further comprising a computerized processing unit that:
receives signals from the electronic image sensor and constructs a digital image of the imaging region of the sample stage;
identifies the locations of molecules of interest; and
causes at least one molecule to be selectively released.

9. The system of claim 8, wherein the computerized processing unit further:
controls the flow of fluid into and out of the sample stage; and
switches on and off the light source.

10. The system of claim 1, further comprising a computerized processing unit that:
receives signals from the electronic image sensor and constructs a digital image of the imaging region of the sample stage; and
identifies the locations of molecules of interest based on the presence of a particular fluorophore tagged to at least some of the molecules.

11. The system of claim 1, further comprising a computerized processing unit that:
receives signals from the electronic image sensor and constructs a digital image of the imaging region of the sample stage; and
identifies the locations of molecules of interest based on the presence of two fluorophores tagged to at least some of the molecules.

12. The system of claim 11, wherein the computerized processing unit measures the distance between two fluorophore tags on a single molecule to a resolution that is smaller than the resolution of the optical system.

13. A method of sorting molecules, the method comprising:
admitting fluid into a sample stage, the fluid carrying a set of molecules, at least some of which are tagged with fluorophores;
identifying a subset of the molecules based on the locations of the fluorophore tags;
immobilizing at least some of the molecules in the subset; and
washing from the sample stage molecules that are not immobilized.

14. The method of claim 13, wherein immobilizing at least some of the molecules comprises providing a plurality of focused beams that immobilize at least some of the molecules using optical tweezers.

15. The method of claim 14, wherein immobilizing at least some of the molecules comprises:
bonding a dielectric object to at least one molecule; and
immobilizing the dielectric object using the optical tweezer.

16. The method of claim 13, wherein identifying the subset of the molecules comprises detecting that certain molecules are tagged with a particular fluorophore tag.

17. The method of claim 13, wherein identifying the subset of the molecules comprises detecting that certain molecules are tagged with two fluorophore tags.

18. The method of claim 17, wherein indentifying the subset of the molecules comprises measuring the spatial separation of the two fluorophore tags on a particular molecule.

19. The method of claim 18, wherein measuring the spatial separation of the two fluorophore tags on a particular molecule comprises measuring the separation using statistical techniques to measure a separation that is smaller than a resolution limit of an imaging system used to detect the fluorphore tags.

20. The method of claim 18, wherein, wherein the two fluorophore tags emit light having different wavelength characteristics.

21. A microfluidic cartridge, comprising:
a molecule fluid input reservoir;
a washing fluid input reservoir;
at least two output reservoirs;
a sample area comprising a transparent portion enabling immobilization of molecules in the sample area using optical tweezers;
a system of channels connecting the reservoirs with the sample area;
a pump for delivering fluid from the molecule fluid input reservoir to the sample area;
a pump for delivering fluid from the washing fluid input reservoir to the sample area;
a set of valves for selectively directing fluid flowing from the sample area to the at least two output reservoirs; and
a set of control lines to actuate the pumps and valves.
